(19) United States
(12) Patent Application Publication
(10) Pub. No.: US 2003/0013479 A1
(43) Pub. Date: Jan. 16, 2003

(54) Mobile communication device preferential system selection

(76) Inventors: Dan Vassilovski, Del Mar, CA (US); Robert S. Daley, Del Mar, CA (US)

Correspondence Address: Qualcomm Incorporated, Patents Department, 5775 Morehouse Drive, San Diego, CA, 92121-1714, US

(21) Appl. No.: 09/905,304

(22) Filed: Jul. 13, 2001

(51) Int. Cl. H04M 1/00

(52) U.S. Cl. 455/552; 455/434; 455/456

(57) ABSTRACT

In a wireless communication system including a campus infrastructure and a wide area infrastructure having a coverage overlapping the campus coverage, CDMA telephones/PDAs preferentially communicate with the campus infrastructure regardless of whether the devices achieve acquisition of the wide area system. The devices can know they are in the campus area based on geographic positioning information or based on probe messages that periodically are transmitted.

### I. FIELD OF THE INVENTION

The present invention relates generally to wireless communication systems such as CDMA systems that provide tiered environments.

### II. BACKGROUND OF THE INVENTION

Wireless communication devices, such as but not limited to wireless telephones and personal digital assistants (PDAs) that communicate using Code Division Multiple Access (CDMA) spread spectrum modulation techniques, can be used to provide tiered communication services. For example, a CDMA telephone might be capable of receiving services from multiple overlapping CDMA systems, such as a primary, wide area CDMA system and a geographically smaller, so-called “campus” system. Establishing a campus system that serves a small region, e.g., a company's business complex, permits campus-specific features such as PBX to be made easily available to devices operating within the campus system. Moreover, using a campus system for communication between devices within the campus area advantageously off-loads communication traffic from the wide area system, thus enhancing network availability particularly for campus system users.

A CDMA wireless device detects and acquires the system serving the area in which the device is located, based on received signal strength. As recognized herein, however, once a CDMA wireless device has acquired a system, it does not attempt to acquire an alternate system unless directed to do so by the serving system or unless the signal strength from the serving system becomes too weak. Thus, for instance, a CDMA wireless device might remain serviced by a wide area system even when it is present in a more preferred, local area that is served by a campus system.

It is further the case that recent regulations mandate that wireless telephones have position sensing capability, either through triangulation techniques or onboard position systems such as GPS. Recognizing this and with the above critical observations in mind, the present invention provides the solutions disclosed herein.

### SUMMARY OF THE INVENTION

A wireless communication device is configured for communicating with a less preferred communication system, such as a wide area communication system and a more preferred communication system, such as a campus CDMA wireless system. The device includes a logic device for preferentially establishing communication with the more preferred communication system even when communication can be established with the less preferred communication system.

In a preferred embodiment, the logic device preferentially establishes communication with the more preferred communication system based on the geographic position of the device. The position can be obtained from a GPS onboard the communication device or from a communication system using triangulation positioning techniques. Or, the device can periodically transmit a probe message to determine what communication systems are available to the device.

In another aspect, a method for preferentially establishing wireless communication between a wireless communication device and a more preferred infrastructure in the presence of a communication path between the device and a less preferred infrastructure includes determining that communication is currently possible between the device and the more preferred infrastructure. The method also includes establishing communication between the device and the more preferred infrastructure regardless of whether a communication path between the device and the less preferred infrastructure exists.

In still another aspect, a communication system includes a campus system and a wide area system having a coverage overlapping the campus system. Wireless communication devices are provided that are capable of communicating with both systems. The devices preferentially communicate with the campus system regardless of whether they achieve acquisition of the wide area system.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a presently preferred wireless communication system;

FIG. 2 is a flow chart of a first embodiment of the present logic;

FIG. 3 is a flow chart of a second embodiment of the present logic; and

FIG. 4 is a flow chart of a third embodiment of the present logic.

### DETAILED DESCRIPTION OF THE PREFERRED EMBODIMENT

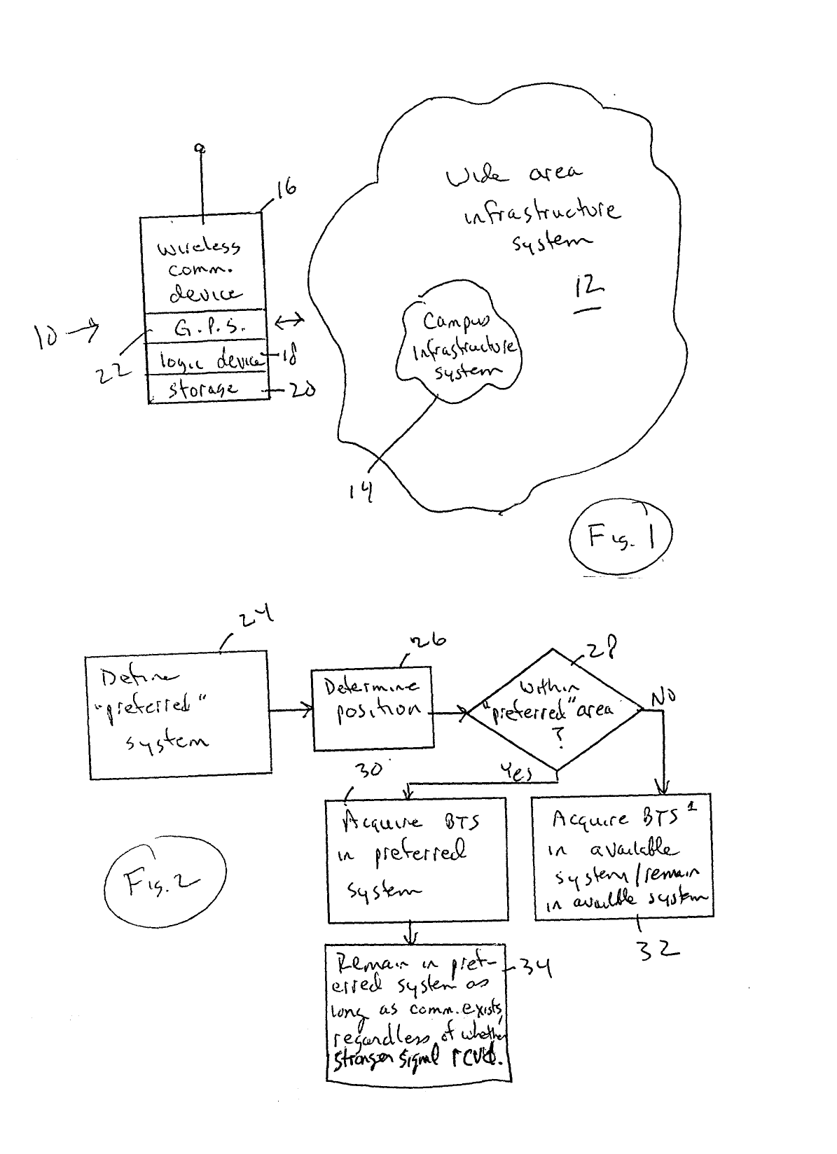

Referring initially to FIG. 1, a wireless communication device, generally designated 10, is shown that is configured for communicating with a wide area wireless communication infrastructure system 12 and a campus wireless communication infrastructure system 14. In one presently preferred but non-limiting embodiment, the wireless device 10 is a code division multiple access (CDMA) telephone or data device such as a personal digital assistant (PDA), and the systems 12, 14 are CDMA systems. More specifically, the wide area system 12 includes base stations (BTS) and can include base station controllers (BSC) and other CDMA infrastructure components known in the art for serving a relatively large geographic area, whereas the campus system 12 can include base stations (BTS), base station controllers (BSC), and other CDMA infrastructure components known in the art for serving a relatively smaller geographic area that can be partially or completely overlapped by the wide area system 12.

In addition to CDMA, the present invention applies to devices 10 and systems 12, 14 that use other types of CDMA including but not limited to WCDMA, cdma2000, TD-SCDMA, as well as other wireless protocol such as but not limited to TDMA, UMTS, etc. In one non-limiting embodiment the communication device 10 is a mobile telephone made by Kyocera, Samsung, or other manufacturer that uses Code Division Multiple Access (CDMA) principles and CDMA over-the-air (OTA) communication air interface protocols such as defined in but not limited to IS-95A, IS-95B, UCDMA, IS-2000, and others to communicate with the systems 12, 14. For instance, the wireless communication systems to which the present invention can apply, in amplification to those noted above, include Personal Communications Service (PCS) and cellular systems, such as Analog Advanced Mobile Phone System (AMPS) and the following digital systems: CDMA, Time Division Multiple Access (TDMA), and hybrid systems that use both TDMA and CDMA technologies. A CDMA cellular system is described in the Telecommunications Industry Association/Electronic Industries Association (TIA/EIA) Standard IS-95. Combined AMPS and CDMA systems are described in TLA/EIA Standard IS-98. Other communications systems are described in the International Mobile Telecommunications System 2000/Universal Mobile Telecommunications Systems (IMT-2000/UM), standards covering what are referred to as wideband CDMA (WCDMA), cdma2000 (such as cdma2000 1× or 3× standards, for example) or TD-SCDMA. The present invention applies to any wireless communication device 10. In general, wireless communication devices to which the present invention applies may include but are not limited to a wireless handset or telephone, a cellular phone, a data transceiver, or a paging and position determination receiver, and can be hand-held, or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as “users” and “mobiles” in some communication systems.

FIG. 1 shows that the wireless device 10 includes a housing 16 that holds a logic device 18 which functions in accordance with the disclosure below for preferentially establishing communication with the more preferred of the communication systems 12, 14 even when communication can be established with the less preferred of the communication systems 12, 14. In an illustrative embodiment, the campus system 14 might be the more preferred system since it is desirable to provide devices 10 with particular services tailored to the campus system 14 when the devices 10 are within communication range of the system 14. Also, when devices 10 communicate through the campus system 14, the amount of communication traffic that the wide area system 12 must bear advantageously is reduced.

It is to be understood that the present logic of the logic device 18 is executed in accordance with the flow charts discussed below. The flow charts herein illustrate the structure of the logic of the present invention as embodied in computer program software, logic circuits, or any other logic device. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus to perform a sequence of function steps corresponding to those shown.

In other words, the logic may be embodied by a computer program that is executed by a processor within the device 10 as a series of computer-executable instructions. These instructions may reside, for example, in RAM of the device 10 or on a hard drive or optical drive of the device 10, or the instructions may be stored on magnetic tape, electronic read-only memory, or other appropriate data storage device. In an illustrative embodiment of the invention, the computerexecutable instructions may be lines of compiled C⁺⁺ compatible code. In one implementation, the logic is implemented in a mobile device using JAVA or BREW.

The communication device 10 also includes a data storage device 20 within the housing 16. Moreover, the communication device 10 can include a positioning device, such as but not limited to a global positioning system 22 supported within the housing 16, to establish the geographic position of the communication device 10 for purposes to be shortly disclosed. Other positioning devices that can be used are disclosed in the following patent documents, all of which are incorporated herein by reference: U.S. Pat. Nos. 6,058,338 and 6,188,354, and U.S. patent application Ser. Nos. 09/741,631, 09/460,180, 09/430,618, and 60/239,318.

Now referring to FIG. 2, one preferred implementation of the logic executed by using the logic device 18 can be seen. Commencing at block 24, one or more “preferred” systems are defined. In the illustration above, the campus system 14 would be defined as a “preferred” system. This definition can be provisioned into the device 10 either during manufacture or subsequently, by a user manually inputting a preferred system identification or by downloading the definition using wireless communication channels and storing it in the storage device 20. A third method could include downloading (or updating) such information using a BREW, JAVA, or other interface subsequent to manufacture at, e.g., a vendor facility. The definition of the preferred system or systems can include geographic boundaries of the system.

Moving to block 26, the geographic position of the communication device 10 is determined. This can be done using the output of the GPS 22. Alternatively, it can be done using triangulation techniques, e.g., the signal from the communication device 10 as received at three or more base stations can be triangulated to determine the position of the communication device 10, with the position being transmitted to the communication device 10 for storage thereof in the storage device 20.

Proceeding to decision diamond 28, the logic device 18 can determine whether the communication device 10 is within the area of the preferred system, e.g., the campus system 14. By “within the area” is meant located within the geographic communication boundary of the preferred system. If so, the logic proceeds to block 30 to establish communication with the preferred system by, e.g., acquiring a base station (BTS) within the infrastructure of the preferred system.

On the other hand, if the communication device 10 is not within the geographic communication boundary of the preferred system, at block 32 the communication device 10 establishes communication with the less preferred system, e.g., the wide area system 12, by, e.g., acquiring a base station (BTS) within the infrastructure of the less preferred system or other available system. It is to be understood that the logic of FIG. 2 can be executed at power-on and periodically thereafter, so that should the communication device 10 initially be forced to communicate with the less preferred system, it will periodically check its position to ascertain whether it is in the area of the more preferred system and if so, preferentially establish communication with the more preferred system regardless of whether it still receives a signal from the less preferred system. Once the communication device 10 acquires the more preferred system, block 34 indicates that it remains in communication with the more preferred system as long as a communication channel therewith exists, regardless of whether a stronger signal is received from an infrastructure component of the less preferred system. It is to be further understood that establishing communication with the less preferred system can also be a continuation of operation on the system, e.g., no change of status in terms of detecting the more preferred system.

As an alternative to the position-based logic shown in FIG. 2, FIG. 3 shows that the communication device 10, after one or more “preferred” systems are defined at block 36, can periodically transmit a probe message at block 38 to determine whether it receives a response from the more preferred system, i.e., to determine whether the more preferred system is available to the communication device 10. If it receives a response at decision diamond 40, the more preferred system is acquired at block 42 in accordance with principles set forth above. Otherwise, the communication device 10 establishes communication with the less preferred but available system at block 44. It is to be understood that establishing communication with the less preferred system can also be a continuation of operation on the system, e.g., no change of status in terms of detecting the more preferred system.

Still further, FIG. 4 shows that after a preferred system is defined at block 46, at block 48 the device can simply search periodically for a unique identifier that can be transmitted by the preferred system, e.g., an offset frequency. If the preferred system is not found at decision diamond 50, a BTS in the less preferred system is acquired at block 52. Otherwise, if desired to improve communication quality a decision can be made at diamond 54 whether the device is within a predetermined range of the preferred system and if so, a BTS in the preferred system is acquired at block 56. Otherwise, the logic flows to block 52 to acquire the less preferred system.

While the particular MOBILE COMMUNICATION DEVICE PREFERENTIAL SYSTEM SELECTION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

What is claimed is:

1. A wireless communication device configured for communicating with at least one less preferred communication system and at least one more preferred communication system, comprising:
a logic device for preferentially establishing communication with the more preferred communication system even when communication can be established with the less preferred communication system.

2. The device of claim 1, wherein the logic device preferentially establishes communication with the more preferred communication system based at least in part on a geographic position of the device.

3. The device of claim 2, wherein the geographic position is received from a global positioning system (GPS) housed in the device.

4. The device of claim 2, wherein the geographic position is received from a communication system using triangulation positioning techniques.

5. The device of claim 1, wherein the device periodically transmits a probe message to determine what communication systems are available to the device.

6. The device of claim 2, wherein the device includes a data storage including information regarding a geographic location of the more preferred communication system.

7. The device of claim 1, wherein the more preferred communication system is a campus communication system and the less preferred communication system is a wide area communication system.

8. The device of claim 7, further comprising means for defining the campus system as the more preferred system.

9. The device of claim 1, wherein the device is a code division multiple access (CDMA) device.

10. The device of claim 9, wherein the device is CDMA telephone.

11. A method for preferentially establishing wireless communication between a wireless communication device and a more preferred infrastructure in the presence of a communication path between the device and a less preferred infrastructure, comprising:
determining that communication is currently possible between the device and the more preferred infrastructure; and
establishing communication between the device and the more preferred infrastructure regardless of whether a communication path between the device and the less preferred infrastructure exists.

12. The method of claim 11, comprising preferentially establishing communication with the more preferred infrastructure based at least in part on a geographic position of the communication device.

13. The method of claim 12, comprising receiving the geographic position from a global positioning system (GPS) housed in the communication device.

14. The method of claim 12, comprising receiving the geographic position from a infrastructure using triangulation positioning techniques.

15. The method of claim 11, comprising periodically transmitting a probe message to determine what infrastructures are available to the communication device.

16. The method of claim 12, comprising storing information regarding a geographic location of the more preferred infrastructure within the communication device.

17. The method of claim 11, wherein the more preferred infrastructure is a campus infrastructure and the less preferred infrastructure is a wide area infrastructure.

18. The method of claim 17, further comprising defining the campus system as the more preferred system.

19. The method of claim 11, wherein the communication device is a code division multiple access (CDMA) device.

20. A communication system, comprising:
a campus system;
a wide area system having a coverage overlapping the campus system; and
plural wireless communication devices capable of communicating with both systems, at least one device preferentially communicating with the campus system regardless of whether the one device achieves acquisition of the wide area system.

21. The system of claim 20, wherein the communication device preferentially communicates with the campus system based at least in part on geographic positions of the device.

22. The system of claim 21, wherein the geographic position is received from a global positioning system (GPS) housed in the device.

23. The system of claim 21, wherein the geographic position is received from a communication system using triangulation positioning techniques.

24. The system of claim 20, wherein the communication device periodically transmits a probe message to determine what communication systems are available to the device.

25. The system of claim 21, wherein the device includes a data storage including information regarding a geographic location of the campus system.

26. The system of claim 20, wherein the device is a code division multiple access (CDMA) device.

27. The system of claim 26, wherein the device is CDMA telephone.

28. A wireless communication device preferentially establishing wireless communication with a more preferred infrastructure in the presence of a communication path between the device and a less preferred infrastructure, comprising:
means for determining that communication is currently possible between the device and the more preferred infrastructure; and
means for establishing communication between the device and the more preferred infrastructure regardless of whether a communication path between the device and the less preferred infrastructure exists.

29. The device of claim 28, comprising means for preferentially establishing communication with the more preferred infrastructure based at least in part on a geographic position of the communication device.

30. The device of claim 29, comprising means for receiving the geographic position from a global positioning system (GPS) housed in the communication device.

31. The device of claim 29, comprising means for receiving the geographic position from a infrastructure using triangulation positioning techniques.

32. The device of claim 28, comprising means for periodically transmitting a probe message to determine what infrastructures are available to the communication device.

33. The device of claim 29, comprising means for storing information regarding a geographic location of the more preferred infrastructure within the communication device.

34. The device of claim 28, wherein the more preferred infrastructure is a campus infrastructure and the less preferred infrastructure is a wide area infrastructure.

35. The device of claim 34, further comprising means for defining the campus system as the more preferred system.

36. A communication system, comprising:
local area communication means;
wide area communication means having a coverage overlapping the local area communication means; and
plural wireless communication means capable of communicating with both area communication means, at least one wireless communication means preferentially communicating with the local area communication means regardless of whether the one wireless communication means achieves acquisition of the wide area communication means.

37. The device of claim 1, wherein the device periodically monitors for a signal from a preferred system.

38. The method of claim 11, comprising periodically listening for an identification signal to determine what infrastructures are available to the communication device.

39. The system of claim 20, wherein the communication device periodically listens for an identification signal to determine what communication systems are available to the device.

40. The device of claim 28, comprising means for periodically monitoring for an identification message to determine what infrastructures are available to the communication device.
